(19) United States
(12) Patent Application Publication
(10) Pub. No.: US 2026/0257951 A1
(43) Pub. Date: Sep. 3, 2026

(54) BUBBLE-FOUNTAIN-TYPE WATER CIRCULATION DEVICE

(71) Applicant: C&C SOLUTION CO.,LTD, Busan (KR)

(72) Inventors: Soo Jung HONG, Busan (KR); Sung Min HONG, Busan (KR)

(73) Assignee: C&C SOLUTION CO.,LTD, Busan (KR)

(21) Appl. No.: 19/462,446

(22) Filed: Jan. 28, 2026

Related U.S. Application Data
(63) Continuation-in-part of application No. PCT/KR2023/021970, filed on Dec. 29, 2023.

(51) Int. Cl. C02F 7/00; B01F 23/234; B01F 25/50; B01F 33/503; B05B 17/08

(52) U.S. Cl. CPC C02F 7/00; B01F 23/23421; B01F 25/50; B01F 33/503; B05B 17/08

(57) ABSTRACT

The present invention relates to a bubble-fountain-type water circulation device and, more specifically, to an improved bubble-fountain-type water circulation device in which a centrifugal pump and a jet pump are combined so as to circulate water through the function of the centrifugal pump and simultaneously suck in air through the function of the jet pump, enabling water of a large reservoir to circulate in a state of high oxygen saturation so that anaerobic water of the bottom layer is pulled up to the surface layer to increase dissolved oxygen levels necessary for the self-purification activity of aerobic microorganisms, thereby effectively improving water quality of the reservoir.

### TECHNICAL FIELD

The present invention relates to a bubble-fountain-type water circulation device, and more particularly, to an improved bubble-fountain-type water circulation device in which a centrifugal pump and a jet pump are combined so as to circulate water through a function of the centrifugal pump and simultaneously suck in air through a function of the jet pump, which enables water of a large-capacity reservoir to circulate with high oxygen saturation, so that anaerobic water of a bottom layer may be pulled up to a surface layer to increase a level of dissolved oxygen that is necessary for self-purification activity of aerobic microorganisms, and thus water quality of the reservoir may be effectively enhanced.

### BACKGROUND ART

Water in a reservoir, a stagnant lake, or the like, which serves as a water source for supplying drinking water, may be spoiled.

In general, the water in the reservoir or the lake is divided into an epilimnion and a hypolimnion according to a water depth, in which a portion extending to a water depth of approximately 8 m is referred to as the epilimnion, which smoothly makes contact with atmosphere so that an oxygen concentration is relatively high, and thus plankton are active. However, when plankton reach their reproductive limits, plankton die so as to be deposited on a bottom surface of the water, which causes organic matters to decompose in the hypolimnion extending to a water depth of 18 m or more, so that nutrient salt such as nitrogen or phosphorus may be produced as decomposition products, which spoils the water.

In addition, with the development to modern society, population density is increased, and the use of chemically synthesized products is increased, so that contaminant emissions are also increased, which causes various contamination sources to flow into a reservoir, a lake, or the like, and thus contamination, eutrophication, green algae, and the like caused by the contamination sources are frequently occurring.

Although multilateral efforts are being made to solve the above problems, the problems involve extremely large-scale areas, so that costs are increased exponentially.

The most practical alternative is to assess water quality within the reservoir or the lake, and insert appropriate decontamination chemicals corresponding to the water quality. However, this leads to further contamination, and human body harmfulness issues continue to arise.

As one of the related art relevant thereto, there is Patent Document 1 (Korean Utility Model Registration No. 20-0261489, Upward Vertical Aeration Underwater Oxygen Supply Device).

Patent Document 1 has a simple circulation structure installed in an aeration tank to suck and discharge water by a fan so as to perform aeration, thereby preventing contamination.

However, the structure of Patent Document 1 is difficult to treat large volumes, and has structural limitations that installation and use in an open space such as a reservoir or a lake are not enabled while installation in a limited space such as an aeration tank is facilitated.

In addition, since a simple suction-discharge scheme is adopted, an aeration capacity is weak, which makes it difficult to treat large volumes, so that there is a limitation in resolving eutrophication.

As another related art, there is Patent Document 2 (Korean Unexamined Utility Model Publication No. 20-1996-0037409, Reservoir Water Quality Improvement Device).

Patent Document 2 has a configuration anchored to a reservoir so as to pull up and circulate water from a deep layer of the reservoir, thereby contributing to resolution of contamination.

Although this is a concept that coincides with the present invention, there are limitations that a simple impeller structure has a weak aeration dispersion capacity so as to have reduced efficiency.

Therefore, the above structure is not suitable for a large-volume long-time treatment, which requires improvement.

As still another related art, there is Patent Document 3 (Korean Patent Registration No. 10-1341136, Real-Time Water Quality Management System for Reservoir or Stream).

Patent Document 3 has a configuration in which contamination information such as a type of a contamination source within a reservoir and a contamination concentration and dynamic information such as a water depth, a water level, a flow velocity, and a flow rate are continuously measured in real time so as to accurately assess conditions within the reservoir, insertion positions of chemicals are changed in real time according to the conditions so as to arrange the chemicals to be concentrated near the contamination source or arrange the chemicals in positions that are organically interconnected to each other, and insertion amounts of the chemicals inserted at respective positions are differentially applied, so that the contamination source may be removed more rapidly.

However, Patent Document 3 has limitations in capability to treat multiple simultaneous contamination because it is limited to resolution of partial decontamination, and particularly has limitations that treatment is performed by using chemicals.

### DISCLOSURE

### Technical Problem

The present invention has been created to solve various problems of the related art described above, and a main object of the present invention is to provide an improved bubble-fountain-type water circulation device in which a centrifugal pump and a jet pump are combined so as to circulate water through a function of the centrifugal pump and simultaneously suck in air through a function of the jet pump, which enables water of a large-capacity reservoir to circulate with high oxygen saturation, so that anaerobic water of a bottom layer may be pulled up to a surface layer to increase a level of dissolved oxygen that is necessary for self-purification activity of aerobic microorganisms, and thus water quality of the reservoir may be effectively enhanced.

### Technical Solution

To achieve the object described above, according to the present invention, there is provided a bubble-fountain-type water circulation device including: a suction pipe installed underwater in a reservoir or a lake; an impeller connected to the suction pipe; and a distribution plate for discharging deep water sucked in by the impeller in a radial direction, wherein the deep water sucked up by the impeller is mixed with external air through the distribution plate so as to increase oxygen saturation, and dispersed upward above surface water.

In this case, the suction pipe may include a stretchable pipe having a bellows shape.

In addition, a support for allowing a lower end of the suction pipe to be spaced apart from a bottom surface of the reservoir or the lake by a predetermined height may be further installed at the lower end of the suction pipe.

In addition, an upper end of the suction pipe may be fixed to a main body housing, at least a portion of the impeller may be embedded in the main body housing, and the distribution plate may be fixed to an upper portion of the main body housing at an upper position of the impeller. In addition, a fixing frame may be installed at a circumference of a lower end of the main body housing.

In addition, one end of a fixing bar may be hinge-fixed to a portion of a circumference of the main body housing, a buoyant material may be fixed to an opposite end of the fixing bar, one end of a turnbuckle may be fixed to a longitudinal portion of the fixing bar, an opposite end of the turnbuckle may be fixed to an upper plate, the upper plate may be fixed to an upper end of the vertical frame, a lower end of the vertical frame may be vertically fixed onto the fixing frame, and a fixing plate perforated with a hole having a predetermined size may be seated on an open upper end of the main body housing.

A plurality of legs may be fixed to the vertical frame.

In addition, at least one wire may be tied to the circumference of the main body housing, and an anchor may be fixed to an end of the wire.

In addition, a fixing plate perforated with a hole having a predetermined size may be seated on an open upper end of the main body housing, the vertical frame may be fixed to the fixing frame, an upper plate may be fixed to an upper end of the vertical frame, a driving motor may be fixed to a top surface of the upper plate, a rotational shaft of the driving motor may pass through the upper plate so as to be coupled to an impeller shaft by a coupler in a space between the upper plate and the fixing plate, the distribution plate may be fixed around a circumference of the hole formed at a center of the fixing plate, and the impeller shaft may pass through the distribution plate so as to be fixed to the impeller.

In addition, the impeller may be configured such that a lower end of the impeller shaft may be bearing-fixed onto a shaft support fixed to a bottom surface of a fixing plate, an impeller shaft may be fixed to a center of an impeller plate, the shaft support may be disposed within a main body housing, the impeller plate may be disposed at a hole formed at a center of the distribution plate, and a horizontal blade and a vertical blade may be formed on a bottom surface of the impeller plate.

In addition, a plurality of vanes radially arranged at intervals may be further formed on a top surface of the impeller plate.

In addition, a plurality of guide vanes radially arranged at a predetermined intervals may be fixed onto a surface of the distribution plate, an upper portion of the guide vane may be covered by a vane cover plate, and a hole to which an impeller plate is fitted may be formed at a center of the vane cover plate.

In addition, the guide vane may be curved in a clockwise or counterclockwise direction.

In addition, a plate surface of the vane cover plate may be perforated with a plurality of fixing grooves in the radial direction, and fitting protrusions may protrude from upper ends of the guide vanes so as to be fitted and fixed to the fixing grooves, respectively.

In addition, the hole formed at the center of the vane cover plate may have a larger diameter than the impeller plate so that a gap may be formed between the vane cover plate and the impeller plate.

In addition, a serrate concavo-convex portion may be formed on a circumferential surface of the distribution plate.

In addition, a plurality of suction holes may be further formed in the vane cover plate in the radial direction so as to correspond to the guide vanes.

In addition, the suction hole may be formed in a rectangular shape, in which three sides are cut, and the remaining one side is attached to the vane cover plate such that the cut portion is inclined downward.

### Advantageous Effects

According to the present invention, the following effects may be achieved.

First, anaerobic water of a bottom layer can be pulled up to a surface layer through vertical blades of a centrifugal pump with 1,760 RPM to increase a level of dissolved oxygen that is necessary for self-purification activity of aerobic microorganisms.

Second, water can be circulated through horizontal blades of the centrifugal pump, and simultaneously, air can be sucked in through a function of a jet pump using a pressure difference caused by a high flow rate, so that water of a large-capacity reservoir can circulate with high oxygen saturation, and thus water quality of the reservoir can be effectively enhanced.

Third, a large volume of water can circulate by sucking in air and aerating the water, which contributes to a rapid self-purification function and improved water quality.

Fourth, water can be sprayed in a radial direction like a fountain, so that a visual effect in the form of a fountain show can be obtained.

### DESCRIPTION OF DRAWINGS

FIG. 1 is an exemplary sectional view showing a device according to the present invention.

FIG. 2 is an exemplary plan view showing the device according to the present invention.

FIGS. 3a and 3b are exemplary views showing structures of a distribution plate and an impeller constituting the device according to the present invention.

FIGS. 4a and 4b are exemplary views showing the structures of the distribution plate and the impeller constituting the device according to the present invention.

FIG. 5 is an exemplary view showing the impeller constituting the device according to the present invention.

FIGS. 6 and 7 are explanatory views for describing a fluid flow upon an operation of the distribution plate and the impeller of FIG. 3.

FIGS. 8a, 8b, and 8c are exemplary views showing another example of structures of a distribution plate and an impeller constituting a device according to the present invention.

FIG. 9 is an explanatory view for describing a fluid flow upon an operation of the distribution plate and the impeller of FIG. 8.

FIG. 10 is a block diagram showing an additional configuration of a bubble-fountain-type water circulation device according to other embodiments of the present invention.

FIG. 11 is an exemplary view showing a water treatment agent spraying apparatus constituting a device according to the present invention.

### MODE FOR INVENTION

Hereinafter, exemplary embodiments of the present invention will be described in more detail with reference to the accompanying drawings.

Before describing the present invention, the following specific structural or functional descriptions have been illustrated to describe embodiments according to the concept of the present invention only, so that the embodiments according to the concept of the present invention may be implemented in various forms and should not be construed as being limited to the embodiments described in the present disclosure.

In addition, since various modifications can be made to the embodiments according to the concept of the present invention, and the embodiments according to the concept of the present invention may have various forms, specific embodiments will be illustrated in the drawings and described in detail in the present disclosure. This, however, is by no means to restrict the embodiments according to the concept of the present invention to a specific disclosed form, and the embodiments according to the concept of the present invention shall be construed as encompassing all modifications, equivalents, and substitutes falling within the idea and technical scope of the present invention.

A bubble-fountain-type water circulation device according to the present invention may refer to a device that pulls up anaerobic water of a bottom layer to a surface layer through an impeller having a high rotation speed of 1,760 RPM to increase a level of dissolved oxygen that is necessary for self-purification activity of aerobic microorganisms.

In particular, the present invention may have a structure in which functions of a centrifugal pump and a jet pump are combined so as to circulate water through the function of the centrifugal pump and simultaneously suck in air through the function of the jet pump, which enables water of a large-capacity reservoir to circulate with high oxygen saturation, so that water quality of the reservoir may be effectively improved.

In other words, the water of the bottom layer having deficient dissolved oxygen may be pulled up to the surface layer by using the centrifugal pump through a suction hose (3-10 m) formed of a urethane material and capable of contraction and expansion, and the air may be sucked in through a suction part through the function of the jet pump caused by a high flow velocity at an outlet of the centrifugal pump so as to increase oxygen saturation and spray the water in the form of a fountain without a separate external air supply device.

In this case, the centrifugal pump may refer to a pump that utilizes a centrifugal force generated by rotating an impeller to exert a rotational force to a liquid, in which the liquid introduced into a central portion of the impeller through a suction pipe may receive the rotational force so as to have an increased pressure as the liquid passes between blades (vanes), and may be sprayed in a radial direction by the rotational force.

In addition, the jet pump may refer to a pump including a working nozzle connected to a diffuser and a mixing chamber, in which the working nozzle and the diffuser, which are two portions, may form special fluid flow ducts having various sections, a working fluid may be sprayed from the nozzle at a high pressure and a high velocity, and static pressure energy may be converted into kinetic energy as a fluid flow passes through the nozzle during a spraying process.

According to the present invention, the impeller of the centrifugal pump and the diffuser of the jet pump may be functionally combined so that a spray form in the radial direction may be provided with a high spraying force so as to be configured in the form of a fountain show.

In addition, according to the present invention, spraying and dispersion may be performed in the form of a bubble fountain so as to widen a contact area with oxygen so that oxygen saturation may be rapidly increased, and particularly, a driving system may be implemented without the use of a decelerator, which is difficult to be subjected to maintenance and repair, so that the present invention may be used without failure for a long period of time.

In other words, the bubble-fountain-type water circulation device according to the present invention may include: a suction pipe installed underwater in a reservoir or a lake; an impeller connected to the suction pipe; and a distribution plate for discharging deep water sucked in by the impeller in a radial direction, wherein the deep water sucked up by the impeller is mixed with external air through the distribution plate so as to increase oxygen saturation, and dispersed upward above surface water.

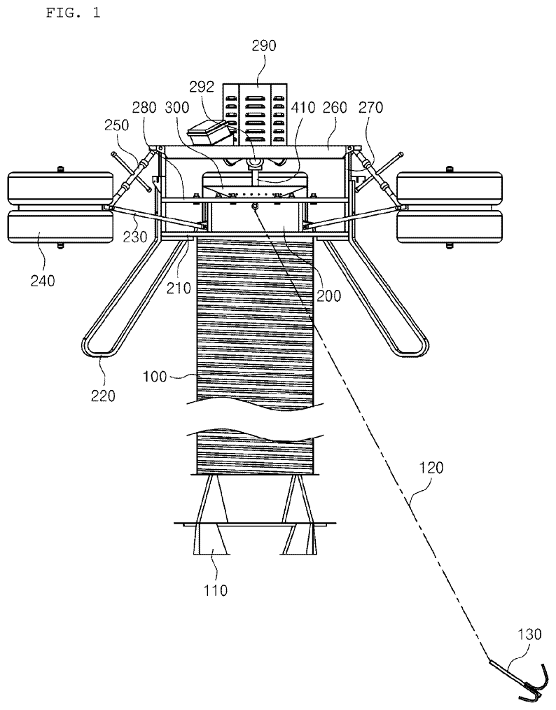

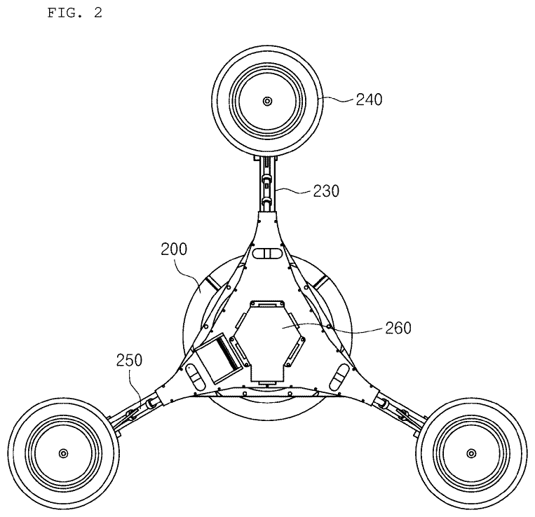

In more detail, as shown in examples of FIGS. 1 and 2, the bubble-fountain-type water circulation device according to the present invention may include a suction pipe 100.

The suction pipe 100 may be installed underwater in the reservoir or the lake.

In other words, the suction pipe 100 may be configured to suck up the deep water, and the deep water that is sucked up may be dispersed upward above surface water.

This may be intended to increase the oxygen saturation by sucking up the deep water, which has relatively less dissolved oxygen than the surface water, and allowing the deep water to make contact with the air over as wide an area as possible.

Then, the water in the reservoir or the lake may be mixed with high oxygen saturation so as to increase a level of dissolved oxygen in the deep water, so that eutrophication may be prevented, and spoiling of the water may be suppressed, and thus contamination may be resolved or prevented.

In addition, the suction pipe 100 may be preferably configured as a stretchable pipe having a bellows shape (also known as a ‘Jabara’ shape) so as to enable length adjustment and minimize a resistance while being deformed according to a flow of the water.

In particular, the suction pipe 100 may be a stretchable pipe formed of a urethane material and capable of contraction and expansion, and may have a length of about 3-10 m.

In addition, a support 110 may be fixed to a lower end of the suction pipe 100.

The support 110 may be a configuration for maintaining the lower end of the suction pipe 100 to be spaced apart from a bottom surface of the reservoir or the lake by a predetermined height.

The reason why the support 110 is required is that the bottom surface of the reservoir or the lake generally has a mud layer somewhat like mud, and when the lower end of the suction pipe 100 is stuck in the mud layer, the deep water may not be sucked in and pulled up.

Meanwhile, the upper end of the suction pipe 100 may be fixed to a main body housing 200.

A fixing frame 210 may be installed at a circumference of a lower end of the main body housing 200.

In this case, the fixing frame 210 does not need to be limited to a specific shape, and may be preferably fixed to a circumference of the main body housing 200 so as to have a triangular shape.

In addition, a vertical frame 270 that is vertically fixed onto the fixing frame 210 may be further provided, and a plurality of legs 220 may be fixed to the vertical frame 270.

The leg 220 may be a configuration that allows the main body housing 200 to be spaced apart from the ground by a predetermined height so as to ensure a space when the main body housing 200 is placed on the ground in order to mount the suction pipe 100 on the main body housing 200 on the ground, thereby facilitating a mounting work.

The leg 220 does not need to be specifically limited, and may preferably have a trivet structure in a tripod shape that matches a shape of the fixing frame 210.

In addition, one end of a fixing bar 230 may be hinged-fixed to a portion of the circumference of the main body housing 200, and a buoyant material 240 may be fixed to an opposite end of the fixing bar 230.

In this case, the buoyant material 240 may be preferably a float, and it may be particularly preferable to provide three buoyant materials 240 spaced at an angle of 120 degrees as shown in the examples.

In addition, a turnbuckle 250 may be fixed to a longitudinal portion of the fixing bar 230 so that the fixing bar 230 may be erected and laid down according to tightening and loosening of the turnbuckle 250.

This may be intended to adjust an immersion depth of the main body housing 200 by adjusting a position of the buoyant material 240 floating on a water surface.

In this case, an opposite end of the turnbuckle 250 may be fixed to an upper plate 260, and the upper plate 260 may be fixed to an upper end of the vertical frame 270.

In addition, a lower end of the vertical frame 270 may be vertically fixed onto the fixing frame 210.

In addition, a fixing plate 280 perforated with a hole having a predetermined size may be seated and fixed to an open upper end of the main body housing 200.

In this case, a shape of the fixing plate 280 does not need to be limited, and the fixing plate 280 may preferably have a triangular shape that corresponds to a shape of the fixing frame 210 together with the upper plate 260 with each vertex firmly fixed to the vertical frame 270.

In addition, at least one wire 120 may be tied to the fixing plate 280, and an anchor 130 may be fixed to an end of the wire 120, so that the anchor 130 may be anchored to the bottom surface of the reservoir or the lake, and thus the main body housing 200 may be anchored in one position without floating.

In addition, a driving motor 290 may be fixed to a top surface of the upper plate 260, a rotational shaft of the driving motor 290 may vertically pass through the upper plate 260 so as to be exposed in a space between the upper plate 260 and the fixing plate 280, and the rotational shaft of the driving motor 290 may be coupled to an impeller shaft 410 by a coupler 292 in the space.

In addition, a distribution plate 300 may be fixed around a circumference of the hole formed at a center of the fixing plate 280 so as to be formed integrally with the fixing plate 280.

Thereafter, the impeller shaft 410 may pass through the distribution plate 300 so as to be inserted into the main body housing 200, and fixed to an impeller 400 having at least portion provided within the main body housing 200.

Therefore, the deep water sucked in through the suction pipe 100 installed underwater in the reservoir or the lake as the impeller 400 rotates may be discharged and dispersed in the radial direction through the distribution plate 300, so that oxygen saturation may be increased through contact with the external air.

In addition, as the above process is repeatedly performed, the deep water and the surface water may be mixed with each other so as to increase a level of dissolved oxygen in the water, so that eutrophication of the reservoir or the lake may be prevented, and contamination may be prevented.

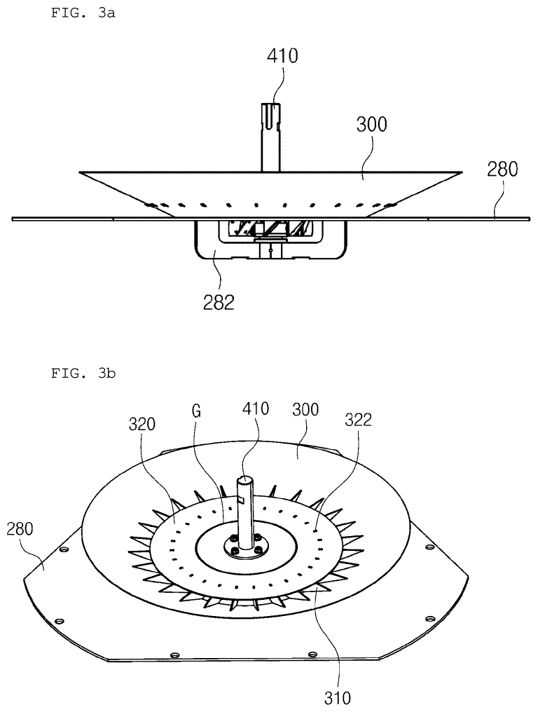

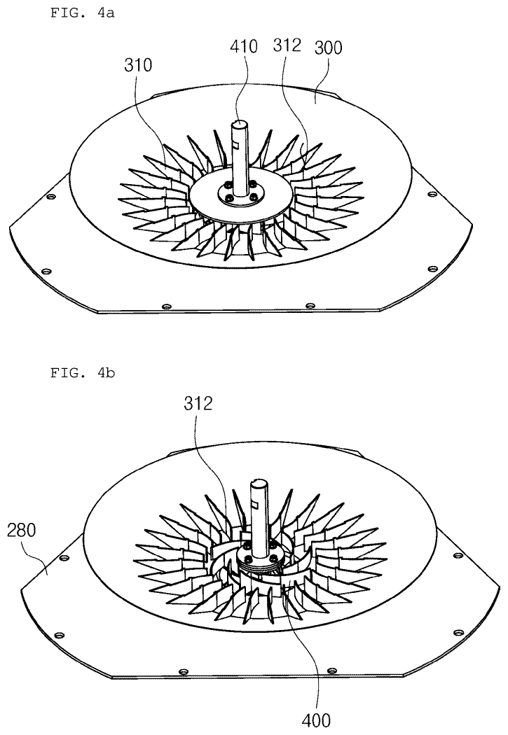

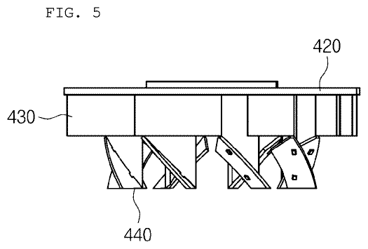

Meanwhile, as shown in examples of FIGS. 3 to 5, the impeller 400 may be configure such that a lower end of the impeller shaft 410 may be bearing-fixed onto a shaft support 282 fixed to a bottom surface of a fixing plate 280, an impeller shaft 410 may be fixed to a center of an impeller plate 420, and the shaft support 282 may be disposed within the main body housing 200.

In this case, the impeller plate 420 may be disposed at a hole formed at a center of the distribution plate 300, and a horizontal blade 430 and a vertical blade 440 may be formed on a bottom surface of the impeller plate 420.

In this case, the vertical blade 440 may provide a suction force in a vertical direction so as to suck up the water of the bottom layer, and the horizontal blade 430 may rotate in a clockwise direction to increase a hydraulic head difference of the water that is sucked in, thereby providing a discharge force of discharging the water in the radial direction.

To this end, horizontal blades 430 may be arranged to form a spiral in the clockwise direction based on the impeller shaft 410, which is a center of a circle, and the vertical blade 440 may have a shape extending in a directly downward direction, which is perpendicular to the impeller plate 420, by a predetermined length, and having an inclined end with a blade plate attached.

Accordingly, a pressure difference may be generated upon rotation so as to cause the deep water to be sucked up.

In addition, a plurality of guide vanes 310 radially arranged at a predetermined interval fixed onto a surface of the distribution plate 300.

The guide vane 310 may be a configuration for smoothly dispersing the deep water discharged by the horizontal blade 430 in the radial direction, and in order to allow the deep water discharged from the horizontal blade 430 to be naturally introduced into the guide vane, the guide vane 310 may be bent in a discharge direction of the horizontal blade 430. However, in the examples of the present invention, as shown in the drawings, the guide vane 310 may be curved in a counterclockwise direction.

The reason why the guide vane 310 is necessary when the horizontal blade 430 constituting the impeller 400 rotates in the clockwise direction to disperse the deep water is that since a body floats on the water, the body may rotate in an opposite direction of the water discharged in a circumferential direction through the horizontal blade 430 due to reaction of the discharged water, the deep water may be discharged in the radial direction by the guide vane 310 so as to eliminate a rotational force so that the device may be stably maintained without rotating, and rotational energy may be converted into discharge energy so as to enable the dispersion at an even higher pressure so that a waterfall-dispersion-type or aeration-type fountain show may be implemented.

In addition, in order to obtain a deep water dispersion effect of the guide vane 310, an upper portion of the guide vane 310 has be sealed, which may be achieved by a vane cover plate 320.

The vane cover plate 320 may be a circular plate having a center in which a hole is formed, and may be fixed to the upper portion of the guide vane 310.

In this case, in order to facilitate the fixing of the vane cover plate 320, a plate surface of the vane cover plate 320 may be perforated with a plurality of fixing grooves 322 in the radial direction, and fitting protrusion 312 may protrude from upper ends of the guide vanes 310 so as to be fitted and fixed to the fixing grooves 322, respectively.

In particular, the hole formed at the center of the vane cover plate 320 has to have a larger diameter than the impeller plate 420 so that a gap G may be formed between the vane cover plate 320 and the impeller plate 420.

The reason why the above configuration is provided is that this is a very important factor in increasing oxygen saturation according to introduction of the external air upon the dispersion of the deep water.

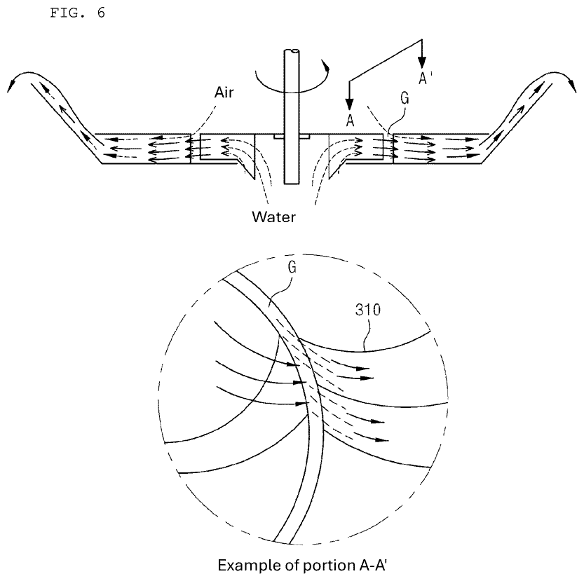

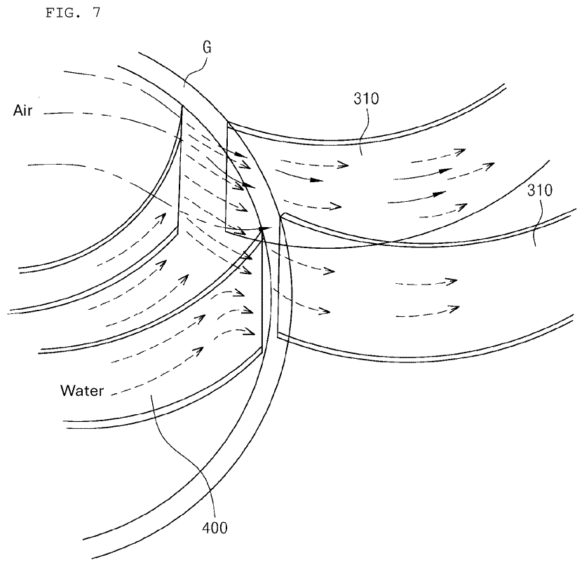

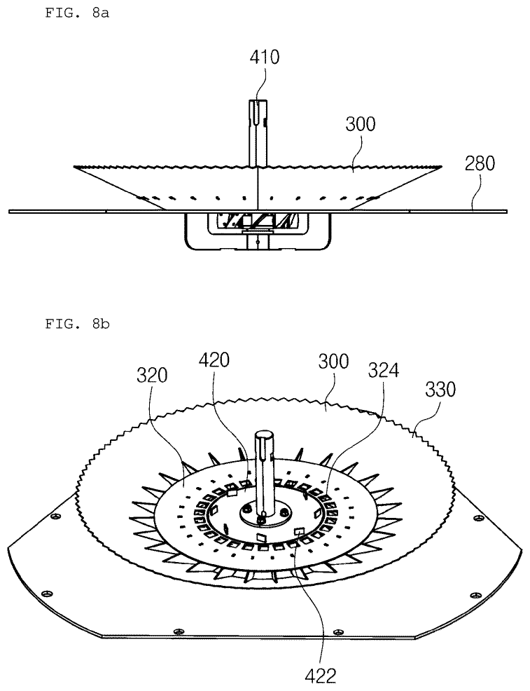

For example, as shown in FIGS. 6 and 7, when the deep water is sucked up, and discharged and dispersed laterally, that is, in the radial direction along the guide vane 310, the external air may be sucked in through the gap G between the vane cover plate 320 and the impeller plate 420, and mixed with the discharged and dispersed deep water, and oxygen saturation of the discharged and dispersed deep water may be increased in this process.

In addition, since the deep water is completely scattered when leaving the guide vane 310 so as to be dispersed into the air, a contact area with the air may be increased exponentially so that the oxygen saturation may be rapidly increased.

In addition, the introduction of the external air may increase a bubbling effect so as to strengthen a discharge dispersion force at an even faster velocity.

Meanwhile, in order to further enhance the effect described above, structures of the distribution plate 300 and the vane cover plate 320 may be improved.

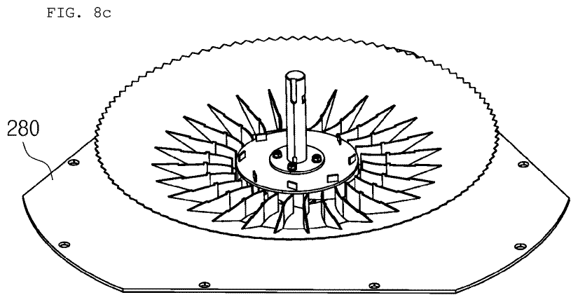

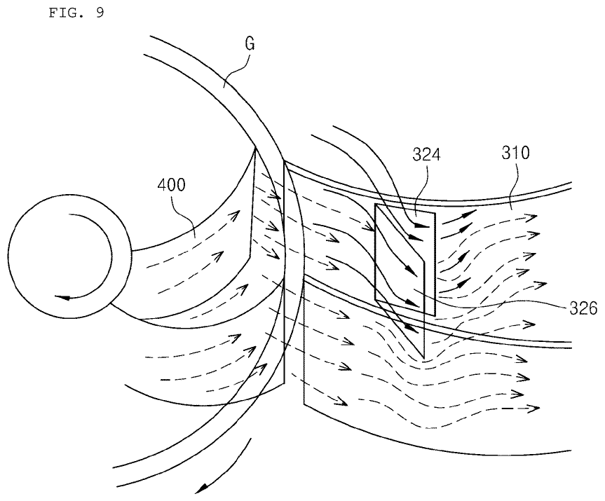

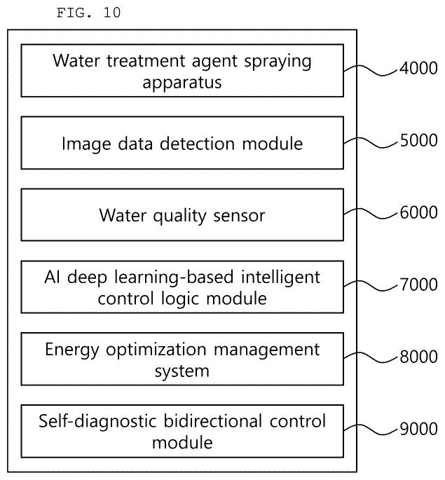

According to FIGS. 8 and 9 shown, a serrate concavo-convex portion 330 may be formed on a circumferential surface of the distribution plate 300.

This may further widen the contact area with the air as the discharged and dispersed water is atomized through a multi-fine saw blade structure, thereby contributing to an increase in oxygen saturation.

In addition, a plurality of vanes 422 radially arranged at intervals may be further formed on a top surface of the impeller plate 420.

The vane 422 may be a configuration for increasing a flow of air in an upper layer of the vane 422 to increase air entrainment, thereby enhancing a discharge capacity.

In addition, a plurality of suction holes 324 may be further formed in the vane cover plate 320 in the radial direction so as to correspond to the guide vanes 310.

The suction hole 324 may be a configuration for obtaining the same effect as the gap G described above while further enhancing performance thereof.

In this case, the suction hole 324 may be formed in a rectangular shape, in which three sides are cut, and the remaining one side is attached to the vane cover plate 320 such that the cut portion is inclined downward.

This may provide a structure capable of preventing water from rising while allowing air to be sucked in easily and rapidly through a Venturi effect.

Accordingly, an air suction effect may also be increased.

Hereinafter, an impeller for a bubble-fountain-type water circulation device according to the present invention will be described in detail.

The bubble-fountain-type water circulation device according to the present invention may include: a suction pipe 100 installed underwater in a reservoir; a main body housing 200 fixedly installed at an upper end of the suction pipe 100; an impeller 400 connected to the suction pipe 100; and a fixing plate 280 perforated with a hole having a predetermined size, and disposed at an open upper end of the main body housing 200, so that deep water sucked up from an underwater portion of the reservoir (or a lake) may be mixed with external air through a distribution plate 300 so as to increase oxygen saturation, and dispersed on surface water of the reservoir.

The impeller 400 may include an impeller shaft 410 and an impeller plate 420; a lower end of the impeller shaft 410 may be bearing-fixed onto a shaft support 282 fixed to a bottom surface of the fixing plate 280, the impeller shaft 410 may be fixed to a center of the impeller plate 420, the shaft support 282 may be disposed within the main body housing 200, the impeller plate 420 may be disposed at a hole formed at a center of the distribution plate 300, and a horizontal blade 430 and a vertical blade 440 may be formed on a bottom surface of the impeller plate 420; the horizontal blade 430 may be formed in a rearward shape (backward curve) at a predetermined height on the impeller plate 420 and inclined upward from a specific point to an inner edge, and the vertical blade 440 may be attached to an inclined surface formed on an inner edge portion of the horizontal blade 430; and the vertical blade 440 may suck in the deep water so as to guide (lead) the deep water to the horizontal blade 430, and the horizontal blade 430 may disperse the deep water.

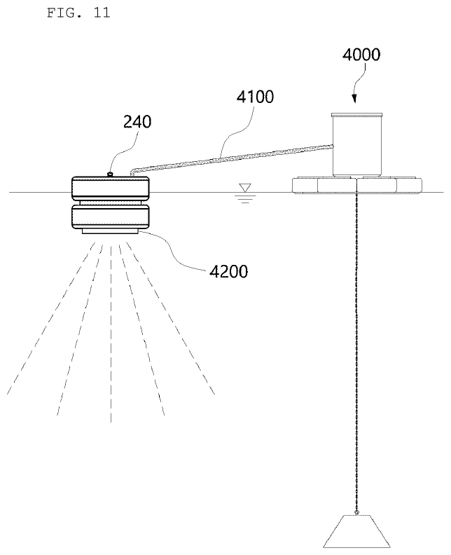

Hereinafter, a bubble-fountain-type water circulation device according to other embodiments of the present invention will be described with further reference to FIG. 10 and FIG. 11.

A bubble-fountain-type water circulation device according to another embodiment of the present invention may further include a water treatment agent spraying apparatus 4000 for enhancing water purification efficiency.

The water treatment agent spraying apparatus 4000 includes a storage tank for storing a water treatment agent, and a mixing unit for mixing the water treatment agent with introduced water.

The inflow of water into the mixing unit is achieved through a separate driving pump, and by directly using raw water at the site where the apparatus is installed, real-time dilution and spraying can be performed without a large-capacity dilution tank.

Such a raw-water utilization structure not only reduces the overall weight of the apparatus to secure operational stability, but also provides convenience in installation and maintenance.

The mixed water treatment agent from the water treatment agent spraying apparatus 4000 is discharged through a spraying unit 4200 (spray nozzle) provided at an end thereof via a water treatment agent transfer pipe 4100. At this time, by using a vertical height difference between the storage tank of the water treatment agent spraying apparatus 4000, which is positioned higher than the water surface, and the spraying unit 4200, the water treatment agent may be configured to be discharged into the water by a siphon principle without providing an additional dedicated pump. In addition, the spraying unit 4200 may be disposed adjacent to a low-pressure region where a high-speed water flow is generated by rotation of the impeller 400, and according to the Bernoulli principle, an inducing effect may occur such that the water treatment agent is more smoothly discharged from the spraying unit 4200.

Further, the water treatment agent discharged from the spraying unit 4200 may be spread over a wider area by the flow of water that is widely dispersed through the distribution plate 300.

When the water treatment agent discharged through the spraying unit 4200 includes beneficial microorganisms, the microorganism particles discharged into the water receive oxygen generated by the bubble-fountain-type water circulation device, whereby aerobic metabolic activity is activated, thereby accelerating decomposition of organic matter in the water and water purification reactions.

The bubble-fountain-type water circulation device according to another embodiment of the present invention may include an image data detection module 5000 for checking a color/condition of a water surface, or a water quality sensor 6000 for measuring water quality.

The image data detection module 5000 for checking the color/condition of the water surface or the water quality sensor 6000 for measuring the water quality may be installed in the water treatment agent spraying apparatus 4000 or the main body of the bubble-fountain-type water circulation device.

The image data detection module for checking the color/condition of the water surface may include a camera, and the water quality sensor may detect chlorophyll a, DO, turbidity, and the like.

The bubble-fountain-type water circulation device according to another embodiment of the present invention may further include an AI deep learning-based intelligent control logic module 7000 for performing AI complex sensing and real-time monitoring, autonomous feedback control, or a prediction-based preemptive response.

When performing the AI complex sensing and real-time monitoring, the AI deep learning-based intelligent control logic module 7000 may be configured to analyze self-diagnostic image data through deep learning or analyze a water quality condition by combining the image data with water quality sensor data, and perform real-time monitoring.

When performing the autonomous feedback control, the AI deep learning-based intelligent control logic module 7000 may intelligently perform automatic control on impeller driving and a water treatment agent spraying amount/time according to an analyzed water quality fluctuation trend.

When performing the prediction-based preemptive response, the AI deep learning-based intelligent control logic module 7000 may perform preventive management to predict a water quality deterioration time point (e.g., a massive green algae bloom time point, etc.) through cumulative data learning, and operate equipment before a threshold is reached.

The bubble-fountain-type water circulation device according to another embodiment of the present invention may further include an energy optimization management system 8000 for intelligently selecting and using grid electricity and renewable energy (e.g., solar energy, wind energy, etc.) according to water quality and remaining energy.

The bubble-fountain-type water circulation device according to another embodiment of the present invention may further include a self-diagnostic bidirectional control module 9000.

The self-diagnostic bidirectional control module 9000 may perform self-condition diagnosis through current/load/vibration detection and AI-based abnormality determination, or perform bidirectional control that enables threshold-based emergency notification transmission and remote adjustment of a manager.

As described above, according to the present invention, a centrifugal pump and a jet pump may be combined so as to circulate water through a function of the centrifugal pump and simultaneously suck in air through a function of the jet pump, which enables water of a large-capacity reservoir to circulate with high oxygen saturation, so that anaerobic water of a bottom layer may be pulled up to a surface layer to increase a level of dissolved oxygen that is necessary for self-purification activity of aerobic microorganisms, and thus water quality of the reservoir may be effectively enhanced.

1. A bubble-fountain-type water circulation device comprising:
a suction pipe installed underwater in a reservoir (or a lake);
an impeller connected to the suction pipe; and
a distribution plate for discharging deep water sucked in by the impeller in a radial direction,
wherein the deep water sucked up by the impeller is mixed with external air through the distribution plate so as to increase oxygen saturation, and dispersed upward above surface water.

2. The bubble-fountain-type water circulation device of claim 1, wherein the suction pipe includes a stretchable pipe having a bellows shape.

3. The bubble-fountain-type water circulation device of claim 1, wherein a support for allowing a lower end of the suction pipe to be spaced apart from a bottom surface of the reservoir (or the lake) by a predetermined height is further installed at the lower end of the suction pipe.

4. The bubble-fountain-type water circulation device of claim 1, wherein an upper end of the suction pipe is fixed to a main body housing, at least a portion of the impeller is embedded in the main body housing, and the distribution plate is fixed to an upper portion of the main body housing.

5. The bubble-fountain-type water circulation device of claim 4, wherein a fixing frame is installed at a circumference of a lower end of the main body housing,
a vertical frame that is vertically fixed onto the fixing frame (210) is further provided, and
a plurality of legs are fixed to the vertical frame.

6. The bubble-fountain-type water circulation device of claim 5, wherein one end of a fixing bar is hinge-fixed to a portion of a circumference of the main body housing, a buoyant material is fixed to an opposite end of the fixing bar, one end of a turnbuckle is fixed to a longitudinal portion of the fixing bar, an opposite end of the turnbuckle is fixed to an upper plate, the upper plate is fixed to an upper end of the vertical frame, a lower end of the vertical frame is vertically fixed onto the fixing frame, and a fixing plate perforated with a hole having a predetermined size is seated on an open upper end of the main body housing.

7. The bubble-fountain-type water circulation device of claim 5, wherein a fixing plate perforated with a hole having a predetermined size is seated on an open upper end of the main body housing, the vertical frame is fixed to the fixing frame, an upper plate is fixed to an upper end of the vertical frame, a driving motor is fixed to a top surface of the upper plate, a rotational shaft of the driving motor passes through the upper plate so as to be coupled to an impeller shaft by a coupler in a space between the upper plate and the fixing plate, the distribution plate is fixed around a circumference of the hole formed at a center of the fixing plate, and the impeller shaft passes through the distribution plate so as to be fixed to the impeller.

8. The bubble-fountain-type water circulation device of claim 7, wherein at least one wire is tied to the fixing plate, and an anchor is fixed to an end of the wire.

9. The bubble-fountain-type water circulation device of claim 1, wherein the impeller is configured such that a lower end of the impeller shaft is bearing-fixed onto a shaft support fixed to a bottom surface of a fixing plate,
an impeller shaft is fixed to a center of an impeller plate,
the shaft support is disposed within a main body housing,
the impeller plate is disposed at a hole formed at a center of the distribution plate, and
a horizontal blade and a vertical blade are formed on a bottom surface of the impeller plate.

10. The bubble-fountain-type water circulation device of claim 9, wherein a plurality of vanes radially arranged at intervals are further formed on a top surface of the impeller plate.

11. The bubble-fountain-type water circulation device of claim 1, wherein a plurality of guide vanes radially arranged at a predetermined interval are fixed onto a surface of the distribution plate, an upper portion of each guide vane is covered by a vane cover plate, and a hole configured to receive an impeller plate is formed at a center of the vane cover plate.

12. The bubble-fountain-type water circulation device of claim 11, wherein the guide vane is curved in a clockwise or counterclockwise direction.

13. The bubble-fountain-type water circulation device of claim 11, wherein a plate surface of the vane cover plate is perforated with a plurality of fixing grooves in the radial direction, and fitting protrusions protrude from upper ends of the guide vanes so as to be fitted and fixed to the fixing grooves, respectively.

14. The bubble-fountain-type water circulation device of claim 11, wherein the hole formed at the center of the vane cover plate has a larger diameter than the impeller plate so that a gap (G) is formed between the vane cover plate and the impeller plate.

15. The bubble-fountain-type water circulation device of claim 11, wherein a serrate concavo-convex portion is formed on a circumferential surface of the distribution plate.

16. The bubble-fountain-type water circulation device of claim 11, wherein a plurality of suction holes are further formed in the vane cover plate in the radial direction so as to correspond to the guide vanes.

17. The bubble-fountain-type water circulation device of claim 16, wherein the suction hole is formed in a rectangular shape, in which three sides are cut, and the remaining one side is attached to the vane cover plate such that the cut portion is inclined downward.

18. The bubble-fountain-type water circulation device of claim 1, further comprising:
a water treatment agent spraying apparatus configured to store a water treatment agent and to discharge the water treatment agent by mixing the water treatment agent with introduced water;
wherein the water treatment agent spraying apparatus is configured such that the water treatment agent is sprayed farther underwater by being carried by a flow of water dispersed through the distribution plate.

19. The bubble-fountain-type water circulation device of claim 1, further comprising:
a water treatment agent spraying apparatus; or
an image data detection module (camera) for checking a color and/or condition of a water surface; or
a water quality sensor for measuring water quality,
wherein the image data detection module or the water quality sensor is further installed on the water treatment agent spraying apparatus or on a main body of the bubble-fountain-type water circulation device.

20. The bubble-fountain-type water circulation device of claim 1, further comprising:
an AI deep learning-based intelligent control logic module configured to perform AI complex sensing and real-time monitoring, autonomous feedback control, or a prediction-based preemptive response.

21. The bubble-fountain-type water circulation device of claim 20, wherein when performing the AI complex sensing and real-time monitoring, the AI deep learning-based intelligent control logic module is configured to analyze self-diagnostic image data through deep learning or analyze a water quality condition by combining the image data with water quality sensor data, and performs real-time monitoring,
when performing the autonomous feedback control, the AI deep learning-based intelligent control logic module intelligently performs automatic control on impeller driving and a water treatment agent spraying amount/time according to an analyzed water quality fluctuation trend, and
when performing the prediction-based preemptive response, the AI deep learning-based intelligent control logic module performs preventive management to predict a water quality deterioration time point through cumulative data learning, and operate equipment before a threshold is reached.

22. The bubble-fountain-type water circulation device of claim 1, further comprising:
an energy optimization management system for intelligently selecting and using grid electricity and renewable energy according to water quality and remaining energy.

23. The bubble-fountain-type water circulation device of claim 1, further comprising:
a self-diagnostic bidirectional control module.

24. The bubble-fountain-type water circulation device of claim 23, wherein the self-diagnostic bidirectional control module is configured to:
perform self-condition diagnosis through current/load/vibration detection and AI-based abnormality determination; or
perform bidirectional control that enables threshold-based emergency notification transmission and remote adjustment of a manager.

25. An impeller for a bubble-fountain-type water circulation device, in which the bubble-fountain-type water circulation device includes: a suction pipe installed underwater in a reservoir (or a lake) ; a main body housing fixedly installed at an upper end of the suction pipe; an impeller connected to the suction pipe; and a fixing plate perforated with a hole having a predetermined size, and disposed at an open upper end of the main body housing, so that deep water sucked up from an underwater portion of the reservoir (or the lake) is mixed with external air through a distribution plate so as to increase oxygen saturation, and dispersed on surface water, the impeller comprising:
an impeller shaft; and
an impeller plate,
wherein a lower end of the impeller shaft is bearing-fixed onto a shaft support fixed to a bottom surface of the fixing plate, the impeller shaft is fixed to a center of the impeller plate, the shaft support is disposed within the main body housing, the impeller plate is disposed at a hole formed at a center of the distribution plate, and a horizontal blade and a vertical blade are formed on a bottom surface of the impeller plate,
the horizontal blade is formed in a rearward shape (backward curve) at a predetermined height on the impeller plate and inclined upward from a specific point to an inner edge, and the vertical blade is attached to an inclined surface formed on an inner edge portion of the horizontal blade, and
the vertical blade sucks in the deep water so as to guide the deep water to the horizontal blade, and the horizontal blade disperses the deep water.

26. An impeller for a bubble-fountain-type water circulation device, the impeller comprising:
an impeller plate,
wherein a horizontal blade and a vertical blade are formed on a bottom surface of the impeller plate,
the horizontal blade is formed in a rearward shape (backward curve) at a predetermined height on the impeller plate and inclined upward from a specific point to an inner edge, and the vertical blade is attached to an inclined surface formed on an inner edge portion of the horizontal blade, and
the vertical blade sucks in the deep water so as to guide the deep water to the horizontal blade, and the horizontal blade disperses the deep water.

27. The impeller of claim 26, wherein a plurality of vanes radially arranged at intervals are further formed on a top surface of the impeller plate.
